(19) United States
(12) Patent Application Publication
(10) Pub. No.: US 2003/0224651 A1
(43) Pub. Date: Dec. 4, 2003

(54) Conducting-wire connector

(76) Inventor: Jung-Wen Chang, Luju Hsiang (TW)

Correspondence Address: RABIN & CHAMPAGNE, PC, 1101 14TH STREET, NW, SUITE 500, WASHINGTON, DC, 20005, US

(21) Appl. No.: 10/318,173

(22) Filed: Dec. 13, 2002

(30) Foreign Application Priority Data
May 29, 2002 (TW) 091207884

(51) Int. Cl. H01R 13/00

(52) U.S. Cl. 439/483

(57) ABSTRACT

A conducting-wire connector used to be coupled to a signal line such that the signal line can be electrically connected to a circuit board via the conducting-wire connector. The conducting-wire connector includes at least a connector body and a exerting section, wherein the connector body is used to be coupled with a signal line and a circuit board whereas the exerting section, which is installed on the connector body, with force being applied onto it, facilitates the connector body to be removed from the circuit board if the connector body is coupled to the circuit board. In practice, the exerting section can be a protruding section, an indenting section or a dragging bar whereas the signal line can be an LCD cable or a flat cable.

This application incorporates by reference of Taiwan application Serial No. 091207884, filed May 29, 2002.

### BACKGROUND OF THE INVENTION

1. Field of the Invention

The invention relates in general to a connector, and more particularly to a connector, which, when coupled to a signal line, enables the signal line to be electrically connected to a circuit board.

2. Description of the Related Art

Along with the rapid growth in the industry of electronic products and the advance in technology, new products are constantly brought forth and marketed. In recent years, portable electronic products, the notebook for example, which cover a versatile range of functions, have already won great popularity of the public.

It is common for a notebook to be installed with a conducting-wire connector, which is an electronic device used to be coupled to a signal line and makes it electrically connected to a circuit board accordingly. Normally a conventional conducting-wire connector is electrically connected to a circuit board. When the conducting-wire connector needs to be removed from the circuit board during repair, force is normally applied onto the signal line, which is electrically connected to the conducting-wire connector. This always ends up with a broken signal line. Therefore, how to remove the conducting-wire connector from the circuit board without damaging the signal line has become an important issue in the research and development of conducting-wire connectors.

Please refer to FIG. 1, a diagram illustrating a conventional conducting-wire connector being coupled with a circuit board. A conventional conducting-wire connector 100 is coupled with a signal line 110 and a circuit board 120, wherein the signal line 110 can be a flat cable or a liquid crystal display (LCD) cable. That is, the electrical connection between the signal line 110 and the circuit board 120 must be done via the conducting-wire connector 100. In order to remove the conducting-wire connector 100 from the circuit board 120, force are normally applied onto the signal line 110. The signal line 110 will be broken easily if its intensity is not strong enough.

It can be known from the foregoing disclosure that a conventional conducting-wire connector has the following disadvantages:

1. It is difficult to remove the conducting-wire connector from the circuit board due to the absence of an exerting section.

2. If the signal line is used as an exerting section, damage will occur easily. Removing the conducting-wire connector from the circuit board by applying force onto the signal line directly is likely to damage the signal line if its intensity is not strong enough.

3. Dissembling tools are needed to remove the conducting-wire connector from the circuit board. If the conducting-wire connector is to be removed from the circuit board without causing damage to the signal line, disassembling tools must be used leading to an avoidable cost increment.

### SUMMARY OF THE INVENTION

It is therefore an object of the invention to provide a conducting-wire connector for the following purposes:

1. Making the removal of the conducting-wire connector easier. With an exerting section being situated on the conducting-wire connector, the conducting-wire connector can therefore be removed from the circuit board easily.

2. Preventing the occurrence of signal line damage. When removing the conducting-wire connector from the circuit board, force are now being applied onto the exerting section of the conducting-wire connector instead of being applied onto the signal line thus protecting the signal line from being damaged.

3. Tool-free removal of conducting-wire connector. No tools are required when removing the conducting-wire connector from the circuit board. When force is applied onto the exerting section of the conducting-wire connector directly, the conducting-wire connector will be removed from the circuit board without using any tools.

The invention achieves the above-identified objects by providing a conducting-wire connector whose structural features are briefed as follows.

A conducting-wire connector used to be coupled to a signal line such that the signal line can be electrically connected to a circuit board via the conducting-wire connector. The conducting-wire connector includes at least a connector body and a exerting section, wherein the connector body is used to be coupled with a signal line and a circuit board whereas the exerting section, which is installed on the connector body, with force being applied onto it, facilitates the connector body to be removed from the circuit board if the connector body is coupled to the circuit board. In practice, the exerting section can be a protruding section, an indenting section or a dragging bar whereas the signal line can be an LCD cable or a flat cable.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1, a diagram shows a conventional conducting-wire connector and a circuit board being coupled together;

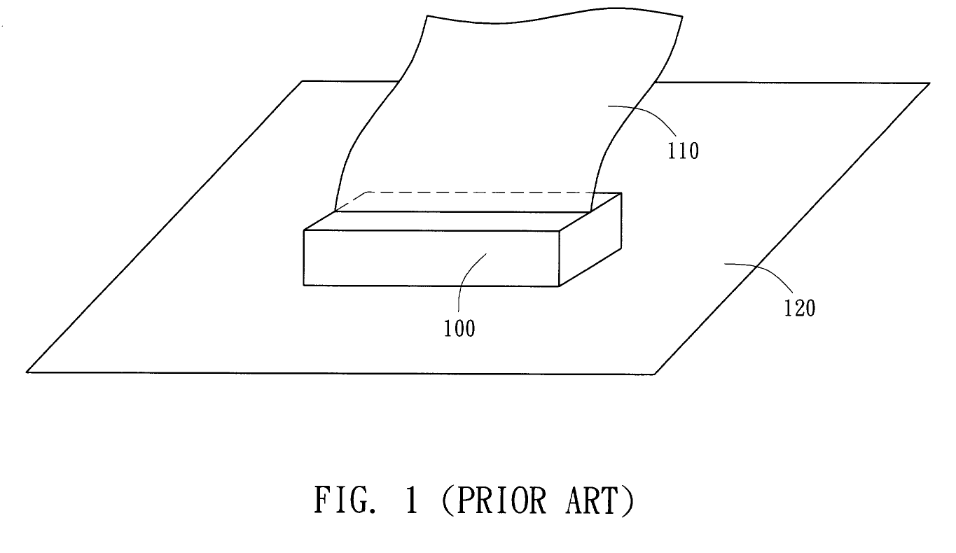

FIG. 2, a diagram shows a conducting-wire connector, whose exerting section provided by a preferred embodiment of the invention is a draw bar, and a circuit board being coupled together;

FIG. 3A, a diagram shows a conducting-wire connector with a exerting section provided by a preferred embodiment of the invention and a circuit board being coupled together; and

FIG. 3B, a diagram shows a conducting-wire connector with an exerting section provided by a preferred embodiment of the invention.

### DETAILED DESCRIPTION OF THE INVENTION

The key point for the conducting-wire connector provided by the invention is as follows. Although the conducting-wire connector is coupled to a circuit board, the conducting-wire connector does not have an exerting section. So force is always applied onto a signal line, which is coupled to the conducting-wire connector. However, the signal line is a signal transmission device, not a loading device. The signal line is likely to be damaged, because its intensity is too weak to take the force applied onto it during the process of removal. If the conducting-wire connector has a exerting section to take the force applied onto it when removing the conducting-wire connector from the circuit board, not only will the removal of conducting-wire connector be made easier and the damage of signal line be prevented, but also a tool-free removing of conducting-wire connector will be achieved. Practical implementations are explained below.

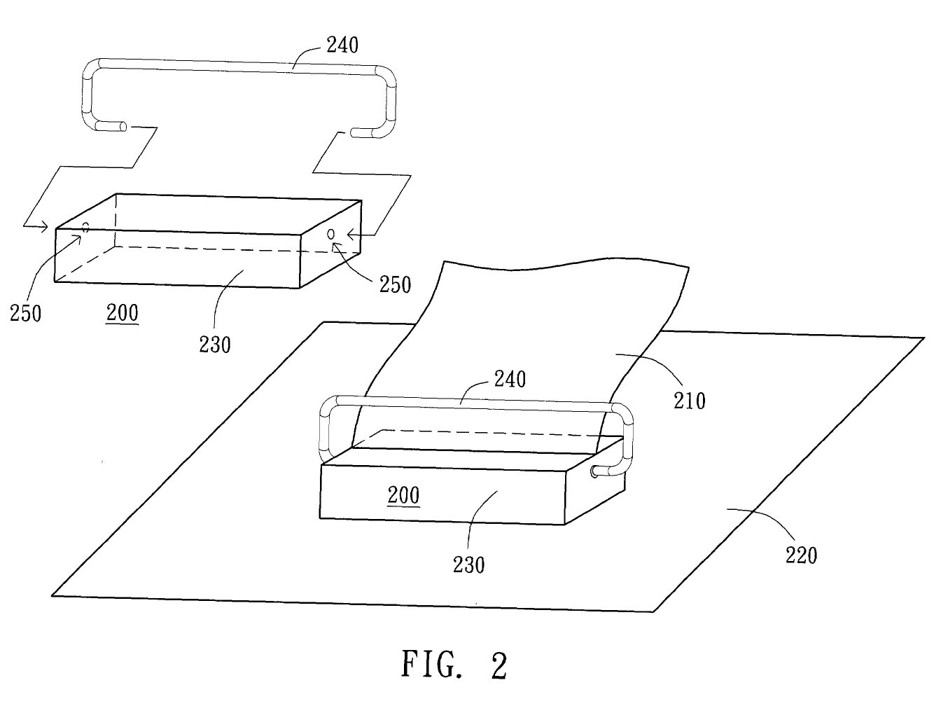

Please refer to FIG. 2, a diagram showing a conducting-wire connector, whose exerting section provided by a preferred embodiment of the invention is a draw bar, and a circuit board being coupled together. A conducting-wire connector 200 is used to be coupled to a signal line 210, an LCD cable or a flat cable for instance, such that the signal line 210 can be electrically connected to a circuit board 220 via the conducting-wire connector 200. The conducting-wire connector 200 includes a connector body 230 and a draw bar 240. In practice, the two ends of the draw bar 240 can be coupled to the two holes 250 respectively which are installed on the two sides of the connector body 230. If the connector body 230 and the circuit board 220 are coupled together as shown in the diagram, the connector 230 will be removed from the circuit board 220 when force are applied onto the draw bar 240.

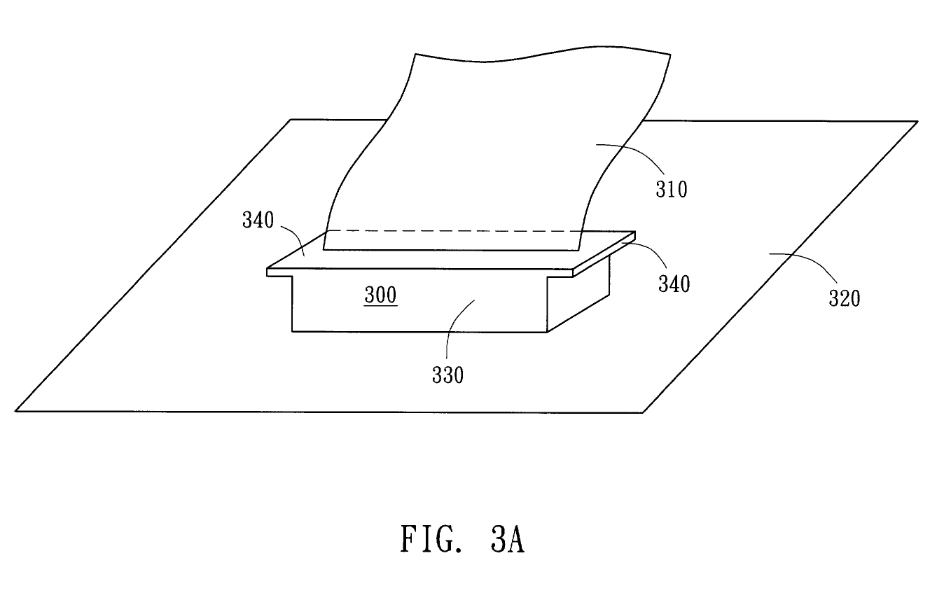

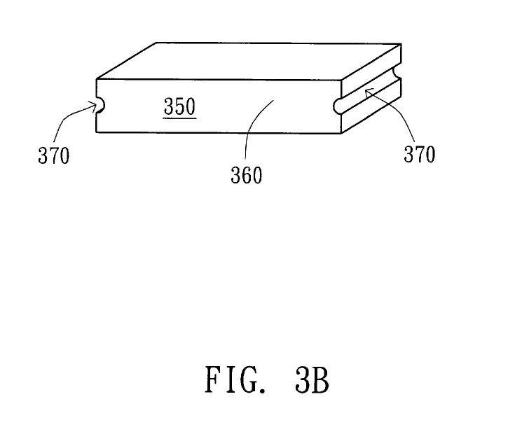

Please refer to FIG. 3A, a diagram showing a conducting-wire connector with an exerting section provided by a preferred embodiment of the invention and a circuit board being coupled together. A conducting-wire connector 300 is used to be coupled to a signal line 310, an LCD cable or a flat cable for instance, such that the signal line 310 can be electrically connected to a circuit board 320 via the conducting-wire connector 300. The conducting-wire connector 300 includes a connector body 330 and an exerting section, wherein the exerting section can be a protruding section 340 for instance. The connector body 330 is coupled with the signal line 310 and the circuit board 320, whereas the protruding section 340 being situated on the lateral side of connector body 330 will take external force applied onto it. Of which, the protruding section 340 can be situated on the two opposite lateral sides or the periphery of the connector body 330. If the connector body 330 and the circuit board 320 are coupled together as shown in the diagram, the connector 330 will be removed from the circuit board 320 when force are applied onto the protruding section 340.

Please refer to FIG. 3B, a diagram showing a conducting-wire connector with an exerting section provided by a preferred embodiment of the invention. The circuit board and the signal line are not shown in this diagram. A conducting-wire connector 350 includes a connector body 360 and an exerting section, wherein the exerting section can be an indenting section 370 for example. Just like the previous preferred embodiment, the connector body 360 is coupled with the signal line and the circuit board, whereas the indenting section 370, whose structure can be a groove or a recess hole for instance, is situated on the lateral side of the connector body 360 and indents into the connector body 360. Of which, the indenting section 370 can be situated on two opposite lateral sides or the periphery of the connector body 360. The indentation of the indenting section has the same function with the protrusion of a protruding section, that is, the indenting section 370 makes it easier to apply force during the process of removing the conducting-wire connector 350 from the circuit board.

The design according to the invention prevents the damage that occurs to the signal line. When removing a conventional conducting-wire connector from a circuit board, force is applied onto the signal line because not any exerting sections on the conducting-wire connector are available. The signal line is likely to be damaged because its intensity is too weak to take the force applied onto it during removal. The design according to the invention not only makes it easier to remove the conducting-wire connector from the circuit board because force can now be applied onto the exerting section, but also helps to save removal cost because not any tools are needed for such a removal.

It is noteworthy that the geometric structure for the parts and elements described in the embodiment of the invention should be regarded as an example of an embodiment of the invention and should not be used to limit the application of the invention. Anyone who is familiar the technology of the invention can make necessary adjustments to achieve a similar function without violating the spirit of the invention.

The conducting-wire connector according to the invention disclosed in the foregoing embodiments has the following advantages:

1. Making the removal of the conducting-wire connector easier. With an exerting section being situated on the conducting-wire connector, the conducting-wire connector can therefore be removed from the circuit board easily.

2. Preventing the occurrence of signal line damage. When removing the conducting-wire connector from the circuit board, force are now being applied onto the exerting section of the conducting-wire connector instead of being applied onto the signal line thus protecting the signal line from being damaged.

3. Tool-free removal of conducting-wire connector. No tools are required when removing the conducting-wire connector from the circuit board. When force is applied onto the exerting section of the conducting-wire connector directly, the conducting-wire connector will be removed from the circuit board without using any tools.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A conducting-wire connector used to be coupled to a signal line so that the signal line is electrically connected to a circuit board via the conducting-wire connector, comprising at least:
a connector body used to be electrically connected with the signal line and the circuit board, wherein a hole is situated on each of the two lateral sides of the connector body; and
a draw bar, wherein the two ends of the draw bar are coupled to the holes respectively;
wherein by applying force onto the draw bar, the connector body will be removed from the circuit board if the connector body is coupled to the circuit board.

2. The conducting-wire connector according to claim 1, wherein the signal line is a flat cable.

3. The conducting-wire connector according to claim 1, wherein the signal line is a liquid crystal display (LCD) cable.

4. A conducting-wire connector used to be coupled to a signal line so that the signal line is electrically connected to a circuit board via the conducting-wire connector, comprising at least:
a connector body used to be electrically connected with the signal line and the circuit board; and
a protruding section which is situated on the connector body and protrudes to the lateral side of the connector body;
wherein by applying force onto the protruding section, the connector body will be removed from the circuit board if the connector body is coupled to the circuit board.

5. The conducting-wire connector according to claim 4, wherein the signal line is a flat cable.

6. The conducting-wire connector according to claim 4, wherein the signal line is a liquid crystal display (LCD) cable.

7. A conducting-wire connector used to be coupled to a signal line and makes it electrically connected to a circuit board via the conducting-wire connector, comprising at least:
a connector body used to be electrically connected with the signal line and the circuit board; and
an indenting section which is situated on the connector body and indents to the lateral side of the connector body;
wherein by applying force onto the indenting section, the connector body will be removed from the circuit board if the connector body is coupled to the circuit board.

8. The conducting-wire connector according to claim 7, wherein the signal line is a flat cable.

9. The conducting-wire connector according to claim 7, wherein the signal line is a liquid crystal display (LCD) cable.
